(19) United States
(12) Patent Application Publication
(10) Pub. No.: US 2023/0256995 A1
(43) Pub. Date: Aug. 17, 2023

(54) METAVERSE AUTONOMOUS DRIVING SYSTEM AND CLUSTER DRIVING

(71) Applicants: Chan Duk PARK, Hwaseong-si (KR); Telme Electronics CO., LTD., Gunpo-si (KR)

(72) Inventors: Chan Duk PARK, Hwaseong-si (KR); Byeong Ryeol CHOI, Osan-si (KR); Dong Ok IM, Siheung-si (KR); Woong Do PARK, Anyang-si (KR); Sung Il PARK, Bucheon-si (KR)

(21) Appl. No.: 17/685,311

(22) Filed: Mar. 2, 2022

(30) Foreign Application Priority Data
Feb. 16, 2022 (KR) 10-2022-0020103

(51) Int. Cl. B60W 60/00; B60W 40/105; G06V 20/58

(52) U.S. Cl. CPC B60W 60/0015; B60W 40/105; G06V 20/58; B60W 2420/42

(57) ABSTRACT

A metaverse autonomous driving system includes a vehicle server that receives camera image signals and a GPS signal, displays a metaverse autonomous driving image, and controls a vehicle in an autonomous driving state, a camera image input device that receives and provides image signals from cameras on the vehicle to the vehicle server in real time, a GPS input device that provides current GPS position information of the vehicle to the vehicle server in real time, a display that provides an I/O interface so that a driver can give an instruction for autonomous driving through a metaverse image, an ECU that operates a vehicle controller on the basis of an autonomous driving control instruction transmitted from the vehicle server, the vehicle controller that controls the vehicle on the basis of the control instruction, and a communication device that wirelessly communicates with other vehicles equipped with the metaverse autonomous driving system.

### CROSS REFERENCE TO RELATED APPLICATION

This application claims priority to and the benefit of Korean Patent Application No. 10-2022-0020103, filed on Feb. 16, 2022, the disclosure of which is incorporated herein by reference in its entirety.

### BACKGROUND OF THE INVENTION

### Field of the Invention

The present disclosure relates to a vehicle equipped with a metaverse autonomous driving system, particularly, to metaverse autonomous driving of a vehicle equipped with a surround camera system for autonomous driving.

The present disclosure relates to autonomous cluster driving of vehicles equipped with a metaverse autonomous driving system.

### Description of the Related Art

An HAD technology that automatically maintains an inter-vehicle distance, a lane departure warning system, a lane keeping support system, a blind-spot collision warning system, advanced smart cruise control, an automatic emergency braking system, etc. are needed to implement an autonomous driving vehicle.

Society of Automotive Engineers (SAE) classified the development level of an autonomous driving vehicle into six steps of level 0 to level 5. The level corresponds to a common vehicle without an autonomous driving function, the level 1 corresponds driving assistant functions such as automatic speed control, the level 2 corresponds to a case that requires continuous monitoring by a driver with partial autonomous driving, the level 3 corresponds to a case in which conditional autonomous driving is performed, a vehicle controls safety functions, and control by passengers is required, the level 4 corresponds to high-level autonomous driving in which control by a driver is not required regardless of the surrounding environment, and the level 5 corresponds to complete autonomous driving, that is, unmanned autonomous driving that drives a vehicle without a person therein.

A surround camera system for autonomous driving filed by the applicant(s) has been registered in Korean Patent No. 10-1778624.

The surround camera system for autonomous driving by the applicant(s), as shown in FIG. 1, includes:

a front view camera that monitors the area ahead of a vehicle and is composed of a visible light camera, a thermal imaging camera, and a front wide-angle camera;

a rear view camera that monitors the area behind the vehicle and is composed of a first rear camera monitoring the right rear area of the vehicle, a second rear camera monitoring the left rear area of the vehicle, and a rear wide-angle camera monitoring the entire rear area of the vehicle, including the right rear and left rear areas of the vehicle;

at least one side view camera that monitors both sides of the vehicle;

a monitoring device that displays images taken through the front view camera, the rear view camera, and the side view camera, an image taken by combining two or more of the images, or a dual image composed of at least one of the images and the combined image;

A Video Control Unit (VCU) that processes and transmits the images taken through the front view camera, the rear view camera, and the side view camera, gives a warning to a driver by sensing and analyzing objects interfering with driving of the vehicle from the obtained images, and controls an Electronic Control Unit (ECU);

a warning device that is connected to the VCU and arouses a driver's attention when a dangerous situation occurs due to the sensed objects;

a GPS that is connected to the VCU;

a manual switch button that manually changes images taken through the front view camera, the rear view camera, and the side view camera, an image obtained by combining two or more of the images, or a dual image composed of at least one of the images and the combined image; and

a warning light that shows an emergency,

in which all directions of 360° around the vehicle is monitored by the front view camera, the rear view camera, and the side view camera,

an image taken through the thermal imaging camera is displayed when it is difficult to recognize the objects from obtained visible light images;

the objects are detected by using the principle that the temperature of the objects is higher than the average temperature of a safety zone when the objects enter the safety zone,

the VCU checks the distances between the objects and the vehicle, the moving direction of the objects, the speed of the objects, the moving direction of the vehicle, the speed of the vehicle, and the color of a traffic light, shows a warning in a state set in advance, and controls and guides the vehicle,

the combined image includes a top view image obtained by processing the images taken through the front view camera, the rear view camera, and the side view camera,

the front wide-angle camera and the rear wide-angle camera are fisheyes lens cameras,

the first rear camera, the second rear camera, and the side view camera are cameras using a Complementary Metal Oxide Semiconductor (CMOS) sensor,

the angle of view of the thermal imaging camera is 20˜40°, the angle of view of the visible light camera is 50˜70°, the angle of view of the front wide-angle camera and the rear wide-angle camera is 110˜130°, the angle of view of the first rear camera and the second rear camera is 75˜85°, and the angle of view of the side view camera is 80˜100°, and images taken through the thermal imaging camera and the visible light camera are both provided at night.

### DOCUMENTS OF RELATED ART

(Patent Document 1) Korean Patent No. 10-1778624 (2017 Sep. 26)

### SUMMARY OF THE INVENTION

Meanwhile, recently, as social, economic, and cultural activities are made in a metaverse that is a virtual world made by copying the real world, there is a need for developing the navigation map, which we use in daily life, into a metaverse-based 3D map.

Autonomous driving vehicles can autonomously drive on the basis of a 3D map constructed in a metaverse that is a reality-like virtual world. That is, when a metaverse 3D map is implemented by copying the buildings and roads of a city, it would be possible to achieve true autonomous driving and smooth traffic flow by accurately estimating changes in traffic volume on the roads.

A vehicle equipped with metaverse autonomous driving system according to the present disclosure includes a surround camera system for autonomous driving.

The metaverse autonomous driving system according to the present disclosure includes a vehicle server, a camera image input device, a GPS input device, a display, an ECU, a vehicle controller, and a communication device.

The vehicle server receives camera image signals and a GPS signal, thereby being able to display a metaverse autonomous driving image, control a vehicle in an autonomous driving state, and control cluster driving while communicating with other vehicles equipped with a metaverse autonomous driving system.

The metaverse autonomous driving system includes software required for metaverse autonomous driving, and an ultra-precision map of driving roads.

The camera image input device receives image signals, which are input from eight cameras of the surround camera system attached to the upper portion of the vehicle, and inputs the image signals to the vehicle server in real time.

The GPS input device inputs the current GPS position information of the vehicle to the vehicle server and includes a Real-Time Kinematic (RTK) GPS system to maintain real-time position information within an error of several centimeters while moving.

The display provides an I/O interface so that a driver can gives an instruction for autonomous driving through a metaverse image.

The ECU, which is an electronic control unit, is a common name of a device that includes an engine control unit and is used for a Transmission Control Unit (TCU), Electronic Stability Control (ESC), airbag control, a Tire Pressure Monitoring System (TPMS), etc.

The ECU operates the vehicle controller on the basis of an autonomous driving control instruction through a CAN communication protocol from the vehicle server.

The vehicle controller controls the vehicle by control of the control instruction from the ECU.

The communication device shares information with other vehicles equipped with the metaverse autonomous driving system through wireless communication.

A vehicle equipped with metaverse autonomous driving system according to the present disclosure can prevent a traffic accident by performing autonomous driving using road data input by a camera system and an ultra-precision roadmap even in the daytime, at night, and in inclement weather.

Further, since a plurality of vehicles equipped with the same metaverse autonomous driving system can perform autonomous cluster driving, reduction of traffic accidents, saving of resources, and economic benefits are expected.

### BRIEF DESCRIPTION OF THE DRAWINGS

The above and other objectives, features and other advantages of the present invention will be more clearly understood from the following detailed description when taken in conjunction with the accompanying drawings, in which:

FIGS. 1 and 2 are diagrams showing a surround camera system for autonomous driving filed by the applicant(s);

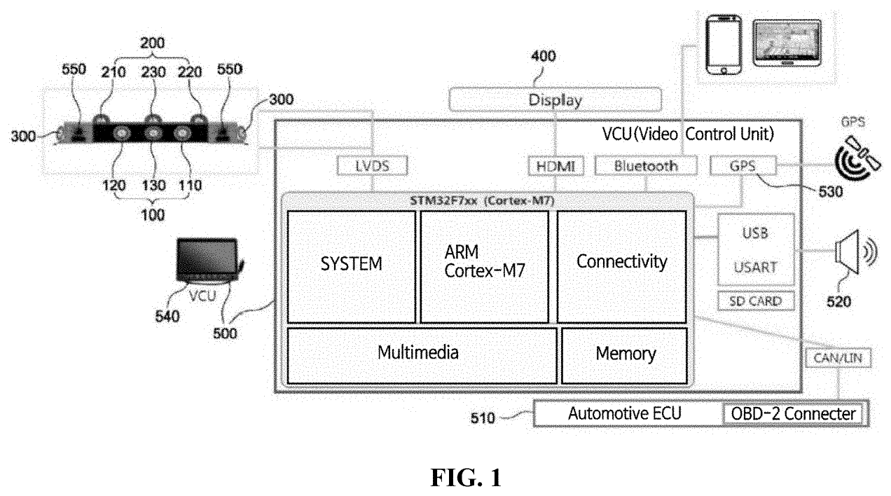

FIG. 3 is a diagram showing a metaverse autonomous driving system according to the present disclosure;

FIG. 4 is a vehicle server according to the present disclosure;

FIG. 5 is a diagram showing an embodiment of an ultra-precision roadmap constructed by dividing an actual driving road into units of cells;

FIG. 6 is a diagram showing an embodiment of an ultra-precision roadmap of an autonomous driving vehicle when the vehicle turns;

FIG. 7 is a diagram showing a metaverse autonomous driving process according to the present disclosure;

FIG. 8 is a conceptual diagram showing autonomous cluster driving of vehicles equipped with the metaverse autonomous driving system according to the present disclosure; and

FIG. 9 is a diagram showing an autonomous cluster driving procedure.

### DETAILED DESCRIPTION OF THE INVENTION

The present disclosure may be modified in various ways and implemented by various exemplary embodiments, so that specific exemplary embodiments are shown in the drawings and will be described in detail.

However, it is to be understood that the present disclosure is not limited to the specific exemplary embodiments, but includes all modifications, equivalents, and substitutions included in the spirit and the scope of the present disclosure. Similar reference numerals are assigned to similar components in the following description of drawings.

Terms used in the present specification are used only to describe specific exemplary embodiments rather than limiting the present disclosure. Singular forms are intended to include plural forms unless the context clearly indicates otherwise. It will be further understood that the terms “comprises” or “have” used in this specification, specify the presence of stated features, steps, operations, components, parts, or a combination thereof, but do not preclude the presence or addition of one or more other features, numerals, steps, operations, components, parts, or a combination thereof.

A metaverse autonomous driving vehicle according to the present disclosure includes the surround camera system for autonomous driving disclosed in Korean Patent No. 10-1778624 by the applicant(s).

The surround camera system for autonomous driving, as shown in FIG. 2, includes two front optical cameras (left and right), a front TOD camera (center), two side COMO cameras (left and right), two rear optical cameras (left and right), and a rear wide-angle camera (center), and may be attached to the upper portion of a vehicle.

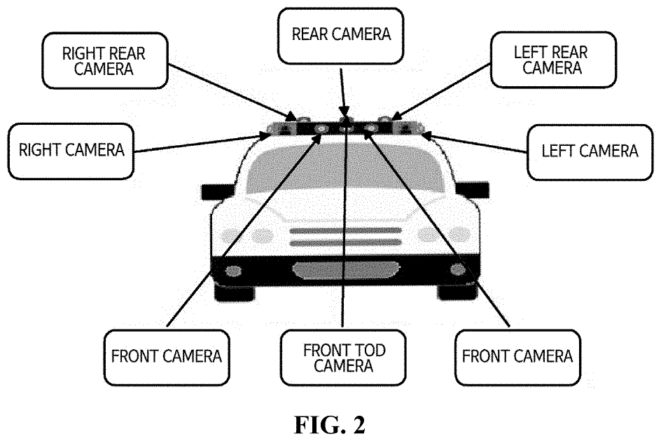

The metaverse autonomous driving vehicle according to the present disclosure includes a metaverse autonomous driving system shown in FIG. 3.

The metaverse autonomous driving system includes a vehicle server 100, a camera image input device 200, a GPS input device 300, a display 400, an ECU 500, a vehicle controller 600, and a communication device.

The vehicle server 100 receives camera image signals and a GPS signal, thereby being able to display a metaverse autonomous driving image, control a vehicle in an autonomous driving state, and control cluster driving while communicating with other vehicles equipped with the metaverse autonomous driving system.

The metaverse autonomous driving system includes software required for metaverse autonomous driving, and an ultra-precision map of a driving road.

The camera image input device 200 receives image signals, which are input from eight cameras of the surround camera system attached to the upper portion of the vehicle, and inputs the image signals to the vehicle server 100 in real time.

The GPS input device 300 inputs the current GPS position information of the vehicle to the vehicle server 100 and includes a Real-Time Kinematic (RTK) GPS system to maintain real-time position information within an error of several centimeters while moving.

The GPS input device 300 is positioned at the center of the surround camera system and determines the positions of four apexes of front, rear, left, and right of the vehicle that is being driven by reflecting the vehicle width based on the distances between four wheels at the front, rear, left, and right of the vehicle.

The display 400 provides an I/O interface so that a driver can give an instruction for autonomous driving through a metaverse image.

The ECU 500, which is an electronic control unit, is a common name of a device that includes an engine control unit and is used for a Transmission Control Unit (TCU), Electronic Stability Control (ESC), airbag control, a Tire Pressure Monitoring System (TPMS), etc.

The ECU 500 operates the vehicle controller 600 on the basis of an autonomous driving control instruction transmitted from the vehicle server 100 in accordance with a CAN communication protocol.

The vehicle controller 600 controls the vehicle on the basis of the control instruction from the ECU 500.

The communication device 700 shares information with other vehicles equipped with the metaverse autonomous driving system through wireless communication.

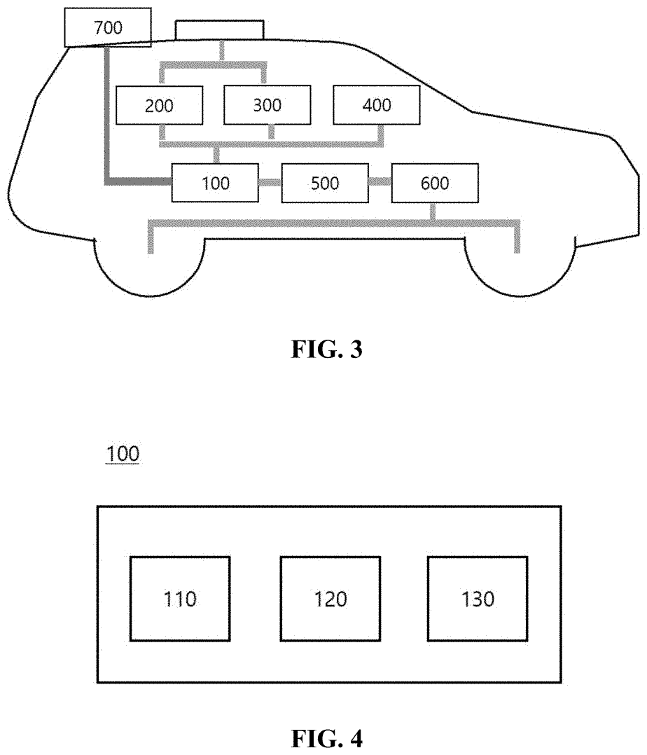

FIG. 4 is a diagram showing in detail the configuration of the vehicle server 100.

The vehicle server 100 includes a metaverse space section 110, an ultra-precision roadmap 120, and a cluster driving section 130.

The metaverse space section 110, which is a part that displays a driving road and an autonomous driving vehicle in a 3D metaverse space, provides a virtual space to a driver through the display 400 using a Computer Graphic (CG) image based on images taken from the surrounding environment and provides an I/O interface for a driver to be able to give an instruction for autonomous driving.

The ultra-precision roadmap 120 is a unit that stores a map completed by dividing a driving road into units of cells to be the same as the actual road environment and designating cell IDs to ultra-precision coordinate values.

The ultra-precision roadmap 120 divides a driving road into units of cells having X and Y coordinates and stores X and Y coordinate values and cell IDs in a map, the map can be output to a driver as a virtual space through the display 400 by the metaverse space section 110, and the vehicle autonomously drives in accordance with the ultra-precision roadmap 120.

The cluster driving section 130 includes a part that shares control information for autonomous cluster driving with other vehicle equipped with the metaverse autonomous driving system through wireless communication, provides an I/O interface for a driver to be able to give an instruction for autonomous cluster driving through the display 400, and controls operation of vehicles that share control information in accordance with a cluster driving procedure.

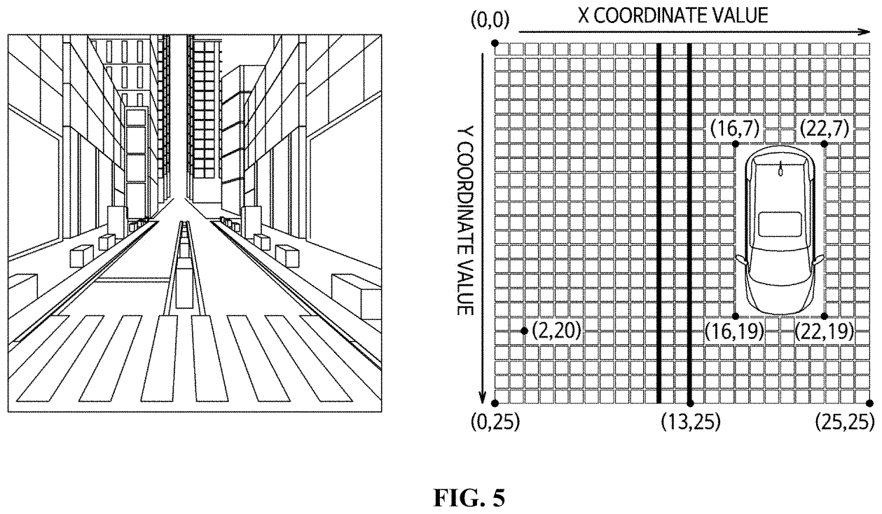

FIG. 5 is a view showing an embodiment of the ultra-precision roadmap 120 constructed by dividing an actual driving road into units of cells.

The ultra-precision roadmap 120 divides a driving road into units of cells having X and Y coordinate values and each cell stores its own ID and X and Y coordinate values. The ultra-precision roadmap 120 may further store the GPS position data of the cells.

The ultra-precision roadmap 120 stores data of buildings around the driving road together with the driving road, and the metaverse space section 110 of the autonomous driving vehicle estimates the current position by comparing building images, which is input from the surround camera system attached to the upper portion of the vehicle, with the building data stored in the ultra-precision roadmap 120.

Further, the metaverse space unit 110 measures the accurate distances between the subject vehicle and the surrounding buildings and determines the current position of the vehicle on the basis of the distances.

The metaverse space section 110 determines the X and Y coordinate values of four apexes of front, rear, left, and right of the autonomous vehicle and displays the autonomous vehicle on the driving road in the ultra-precision roadmap 120.

The autonomous driving vehicle according to the present disclosure can recognize lanes from the image input from the surround camera system, and can also recognize the lane of the driving road from the images of buildings around the driving road input from cameras. This is possible because the ultra-precision roadmap 120 stores the data of building around the driving road together with the driving road.

In the embodiment shown in FIG. 5, when the vehicle is driven straight, the X coordinate value is fixed and the Y coordinate value is changed in real time.

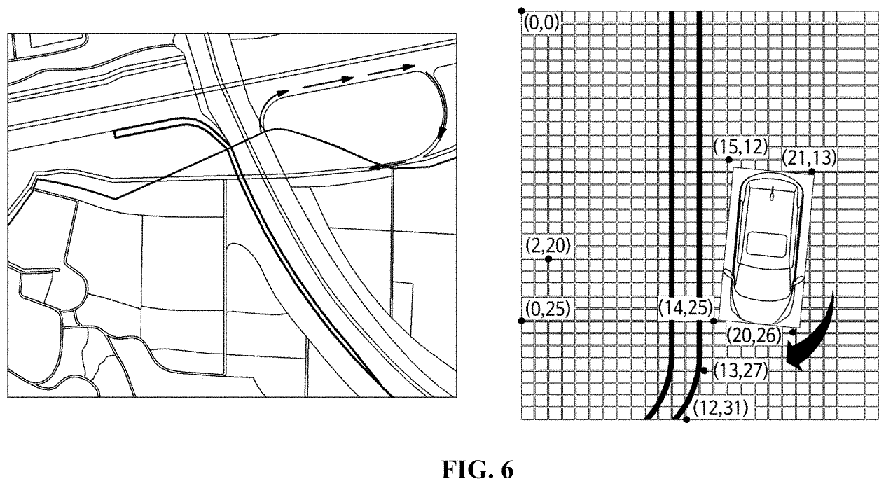

However, when the vehicle is turned, as in the embodiment shown in FIG. 6, the X and Y coordinate values of four apexes of front, rear, left, and right of the autonomous driving vehicle are changed in real time.

The metaverse space section 110 can display all straight sections and turn sections by reading out a real-time current position and the front driving route with delay of processing speed by loading data within 1 km ahead of the autonomous driving vehicle.

When the autonomous driving vehicle is turned on the basis of the loaded data, the X and Y coordinate values of the four apexes of front, rear, left, and right of the vehicle are changed in real time.

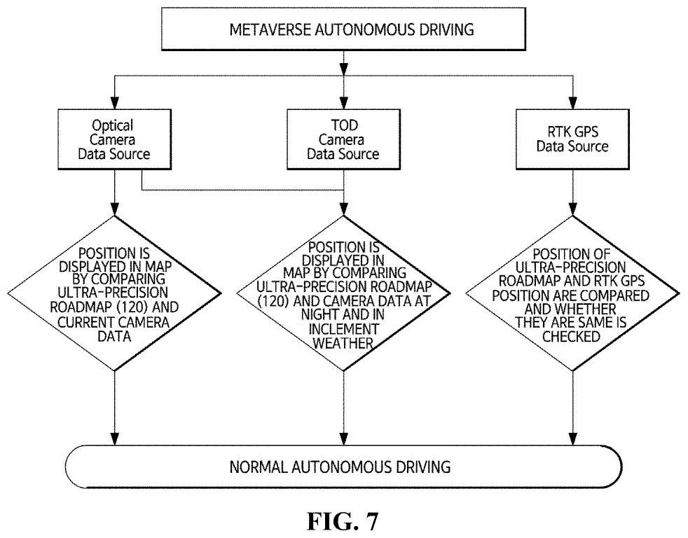

FIG. 7 is a diagram showing a metaverse autonomous driving process according to the present disclosure.

In the daytime, the metaverse autonomous driving system displays the position of the autonomous driving vehicle in a corresponding ultra-precision roadmap 120 and normally gives an instruction for autonomous driving by comparing the data, which are input from the front and rear optical cameras and the CMOS cameras on sides of the camera system attached to the upper portion of the autonomous vehicle, and the data of the ultra-precision roadmap 120.

At night or in inclement weather, the metaverse autonomous driving system displays the position of the autonomous driving vehicle in a corresponding ultra-precision roadmap 120 and normally gives an instruction for autonomous driving by comparing not only the data input from the front and rear optical cameras and the CMOS cameras on sides, but the data input from the front TOD camera with the data of the ultra-precision roadmap 120.

The metaverse autonomous driving system checks whether the GPS data input from the RTK GPS system in the vehicle are the same as the GPS position data of the position of the autonomous driving vehicle displayed on the ultra-precision roadmap 120, and normally gives an instruction for autonomous driving when they are the same.

Meanwhile, normal autonomous driving is difficult when a road under construction or a desert area that has not been input in the ultra-precision roadmap 120 appears. Accordingly, when an undrivable section, such as an road under construction or a desert area, appears in the front driving route, the metaverse autonomous driving system gives an instruction for autonomous driving along a route avoiding the area the road under construction, etc. in the front driving route using the data input from the optical cameras or the TOD camera and an AI algorithm.

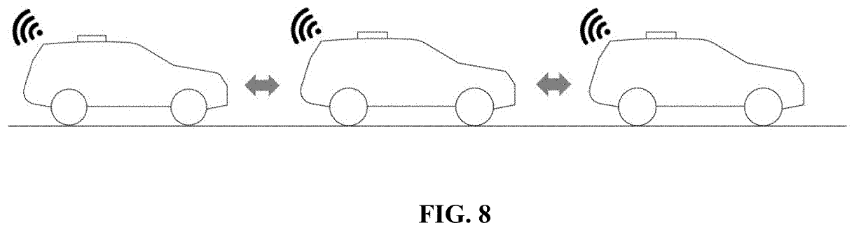

FIG. 8 is a diagram showing autonomous cluster driving of vehicles equipped with the metaverse autonomous driving system according to the present disclosure.

In the vehicles that are in autonomous cluster driving in FIG. 8, the cluster driving section 130 wirelessly communicates with the other vehicles through the communication device 700 and an I/O interface for a driver to be able to give an instruction for control is provided through the display 400.

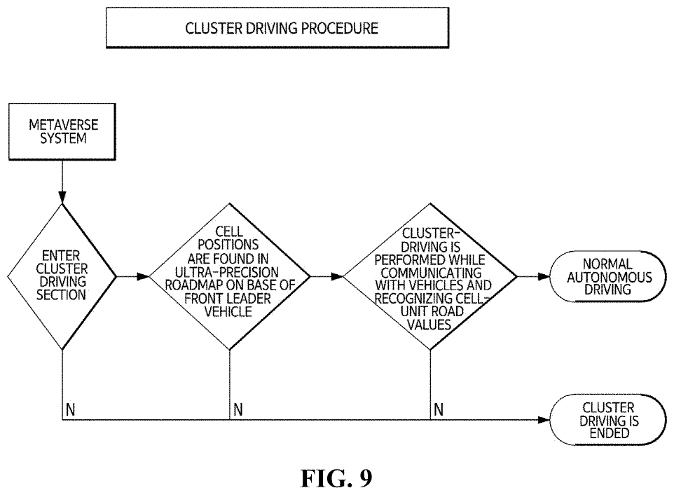

FIG. 9 is a diagram showing an autonomous cluster driving procedure.

First, vehicles enter the cluster driving section 130 for autonomous cluster driving.

The front vehicle of the vehicles entering the cluster driving section 130 is designated as a leader vehicle.

The positions of the vehicles are shared through wireless communication and displayed on the ultra-precision roadmap 120, and autonomous cluster driving is normally performed by the front leader vehicle.

The metaverse autonomous driving vehicle shares information about an emergency warning, whether the tail lamps is broken or not, construction sites, abnormal road situations, etc. during cluster driving.

What is claimed is:

1. A metaverse autonomous driving system comprising:
a vehicle server configured to receive camera image signals and a GPS signal, display a metaverse autonomous driving image, and control a vehicle in an autonomous driving state;
a camera image input device configured to receive image signals from cameras attached to the vehicle and provide the image signals to the vehicle server in real time;
a GPS input device configured to provide current GPS position information of the vehicle to the vehicle server in real time;
a display configured to provide an I/O interface so that a driver can give an instruction for autonomous driving of the vehicle through a metaverse image;
an ECU configured to operate a vehicle controller on the basis of an autonomous driving control instruction transmitted from the vehicle server in accordance with a CAN communication protocol;
the vehicle controller configured to control the vehicle on the basis of the control instruction; and
a communication device configured to wirelessly communicate with other vehicles equipped with the metaverse autonomous driving system.

2. The metaverse autonomous driving system of claim 1, further comprising a surround camera system for autonomous driving that is composed of a front optical camera, a front TOD camera, a side CMOS camera, a rear optical camera, and a rear wide-angle camera and is attached to an upper portion of a vehicle.

3. The metaverse autonomous driving system of claim 1, wherein the vehicle server further includes:
a metaverse space section configured to display a driving road and an autonomous driving vehicle in a 3D metaverse space;
an ultra-precision roadmap configured to store a map completed by dividing the driving road into units of cells and designating cell IDs to ultra-precision coordinate values; and
a cluster driving section configured to control information for autonomous cluster driving with other vehicle equipped with the metaverse autonomous driving system through wireless communication, provide an I/O interface for a driver to be able to give an instruction for autonomous cluster driving, and control cluster driving in accordance with a cluster driving procedure.

4. The metaverse autonomous driving system of claim 3, wherein the metaverse space section is a virtual space using Computer Graphic (CG) based on images taken from an actual surrounding environment.

5. The metaverse autonomous driving system of claim 3, wherein the metaverse space section determines a position of a subject vehicle by measuring accurate distances between the vehicle and surrounding buildings.

6. The metaverse autonomous driving system of claim 1, wherein the GPS input device is positioned at a center of a surround camera system and determines positions of four apexes of front, rear, left, and right of a vehicle that is being driven by reflecting a vehicle width based on distances between four wheels at a front, a rear, a left, and a right of the vehicle.

7. The metaverse autonomous driving system of claim 3, wherein the metaverse space unit displays straight sections and turn sections by reading out a real-time current position and a front driving route with delay of processing speed by loading data within 1 km ahead of an autonomous driving vehicle.

8. The metaverse autonomous driving system of claim 1, wherein the ECU 500, which is an electronic control unit, includes an engine control unit and is used for a Transmission Control Unit (TCU), Electronic Stability Control (ESC), airbag control, and a Tire Pressure Monitoring System (TPMS).

9. The metaverse autonomous driving system of claim 3, wherein the metaverse autonomous driving vehicle shares information about an emergency warning, whether tail lamps break or not, construction sites, and abnormal road situations, during cluster driving.

10. The metaverse autonomous driving system of claim 3, wherein when an undrivable section, such as a road under construction or a desert area that is not input in the ultra-precision map, appears, the metaverse autonomous driving system gives an instruction for autonomous driving along a route avoiding the undrivable section showing up in a front driving route using an AI algorithm.
